(19) United States
(12) Patent Application Publication
(10) Pub. No.: US 2026/0001270 A1
(43) Pub. Date: Jan. 1, 2026

(54) Fabric with Digitally Controlled Characteristics

(71) Applicant: Apple Inc., Cupertino, CA (US)

(72) Inventors: Francois R Jacob, Sunnyvale, CA (US); Daniel A Podhajny, Morgan Hill, CA (US)

(21) Appl. No.: 19/183,550

(22) Filed: Apr. 18, 2025

Related U.S. Application Data
(60) Provisional application No. 63/665,856, filed on Jun. 28, 2024.

(51) Int. Cl. B29C 64/118; B29K 75/00; B29K 105/08; B29L 31/34; B33Y 70/00; B33Y 80/00

(52) U.S. Cl. CPC B29C 64/118; B29K 2075/00; B29K 2105/0809; B29K 2995/0021; B29K 2995/0046; B29L 2031/3418; B33Y 70/00; B33Y 80/00

(57) ABSTRACT

Fabric may include a web of printed strands. Each printed strand may include multiple materials extending along a length of the strand. The materials may include at least first and second materials with one or more different characteristics such as color, melting temperature, modulus of elasticity, etc. The printed strands may have some strand segments in which the first material faces a first direction and the second material faces a second, opposite direction, whereas other strand segments may have the first material facing the second direction and the second material facing the first direction. By rotating the print head nozzle during printing, computing equipment can selectively adjust which regions of the fabric will look and feel like the first material and which regions of the fabric will look and feel like the second material.

This application claims the benefit of U.S. provisional patent application No. 63/665,856, filed Jun. 28, 2024, which is hereby incorporated by reference herein in its entirety.

### FIELD

This relates generally to fabric and, more particularly, to fabric that includes printed strands.

### BACKGROUND

It may be desirable to form voice-controlled assistant devices, bags, covers for electronic devices such as cellular telephones and tablet computers, straps, wristbands, and other equipment from fabric. Fabric-based items such as these may have an attractive appearance and may benefit from desirable attributes associated with fabric such as sound permeability, light weight, and durability.

It can be challenging to produce fabric with the desired characteristics. Fabric may be vulnerable to damage after extended use, may be prone to water damage if used outdoors, and/or may otherwise perform unsatisfactorily.

### SUMMARY

Fabric may include printed strands with digitally controlled characteristics (color, material type, porosity, stiffness, modulus of elasticity, conductivity, fusibility, melting temperature, reflectivity, transparency, etc.). Using additive manufacturing equipment, the printed strands may be printed onto a moving support structure such as a rotating cylinder, sphere, rectangular substrate, and/or any other three-dimensional structure to form one or more printed fabric layers. The printed fabric layers may form a seamless loop of webbing. If desired, non-printed strands may be added around the printed strands to form one or more non-printed fabric layers on top of, embedded in, or otherwise coupled to the printed fabric layers.

Strands may be dispensed from a print head having a digitally controlled, rotating nozzle. The nozzle may have a rectangular aperture, a square aperture, a circular aperture, an oval aperture, and/or an aperture having any other suitable shape. Multiple materials with different characteristics (e.g., different properties) may be dispensed from a common aperture to form a printed strand having different characteristics across the width (thickness, diameter, cross-section, etc.) of the strand. By rotating the nozzle while dispensing the strand, the print head can control which material faces the substrate (and is therefore hidden from view) and which material faces away from the substrate (and is therefore exposed and visible to a viewer).

For example, some segments of a strand may have one color exposed and visible while other segments of the strand may have a different color exposed and visible. Some segments of a strand may be soft and flexible to the touch while other segments of the strand may be hard and rigid to the touch. A given strand dispensed from a print head may have two, three, or more than three materials with different characteristics (e.g., color, material type, porosity, stiffness, modulus of elasticity, conductivity, fusibility, melting temperature, reflectivity, transparency, etc.). The look, feel, and functionality of a printed fabric can be digitally controlled by selectively rotating the print head nozzle such that the desired material is placed in the desired location on the fabric.

### BRIEF DESCRIPTION OF THE DRAWINGS

FIG. 1 is a perspective view of an illustrative electronic device such as a speaker having one or more fabric portions with printed strands in accordance with some embodiments.

FIG. 2 is a schematic diagram of illustrative equipment for forming fabric having printed strands in accordance with some embodiments.

FIG. 3 is a bottom view of an illustrative nozzle having a rectangular cross-section from which first and second materials with different characteristics may be dispensed in accordance with some embodiments.

FIG. 4 is a bottom view of an illustrative nozzle having a rectangular cross-section from which first, second, third, and fourth materials with different characteristics may be dispensed in accordance with some embodiments.

FIG. 5 is a perspective view of an illustrative printed strand with a rectangular cross-section and having first and second materials with different characteristics in accordance with some embodiments.

FIG. 6 is a perspective view of an illustrative print head having a rotating nozzle from which a printed strand with at least first and second materials with different characteristics may be dispensed in accordance with some embodiments.

FIG. 7 is a perspective view of illustrative printed strands that cross over each other and that have materials with different characteristics across a vertical direction in accordance with some embodiments.

FIG. 8 is a side view of an illustrative printed strand with a circular cross-section and first and second materials with different characteristics in accordance with some embodiments.

FIG. 9 is a side view of an illustrative printed strand with a circular cross-section and first and second materials separated by a dissolvable material in accordance with some embodiments.

FIG. 10 is a side view of an illustrative fabric having fused overlapping strands in some crossover locations and unconnected overlapping strands in other crossover locations in accordance with some embodiments.

FIG. 11 is a side view of an illustrative fabric after removing a dissolvable material from selective strands to form fused connections in some crossover locations while other crossover locations remain unconnected in accordance with some embodiments.

FIG. 12 is a top view of an illustrative fabric having printed strands that are selectively fused together in some crossover locations while printed strands in other crossover locations remain unconnected in accordance with some embodiments.

FIG. 13 is a perspective view of illustrative overlapping printed strands having first and second materials with different characteristics across a horizontal direction in accordance with some embodiments.

FIG. 14 is a top view of an illustrative fabric having printed strands of the type shown in FIG. 13 in accordance with some embodiments.

FIG. 15 is a top view of an illustrative fabric overlapping an input device and formed from a web of printed strands with digitally controlled characteristics in accordance with some embodiments.

### DETAILED DESCRIPTION

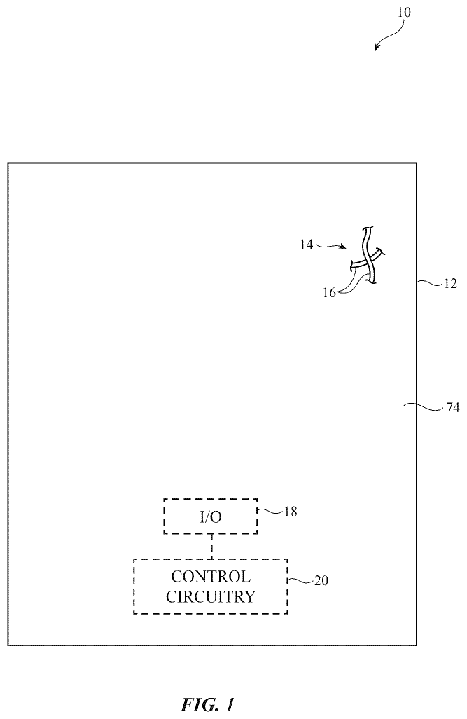

Items such as item 10 of FIG. 1 may include fabric. Item 10 may be an electronic device or an accessory for an electronic device such as a voice-controlled electronic device (sometimes referred to as a digital assistant or voice-controlled speaker), a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which fabric-based item 10 is mounted in a kiosk, in an automobile, airplane, or other vehicle, other electronic equipment, or equipment that implements the functionality of two or more of these devices. If desired, item 10 may be a removable external case for electronic equipment, may be a strap, may be a wrist band or head band, may be a removable cover for a device, may be a case or bag that has straps or that has other structures to receive and carry electronic equipment and other items, may be a necklace or arm band, may be a wallet, sleeve, pocket, or other structure into which electronic equipment or other items may be inserted, may be part of a chair, sofa, or other seating (e.g., cushions or other seating structures), may be part of an item of clothing or other wearable item (e.g., a hat, belt, wrist band, headband, shirt, pants, shoes, etc.), or may be any other suitable fabric-based item. In the illustrative configuration of FIG. 1, item 10 is a voice-controlled electronic device such as a voice-controlled speaker with internet access. Other types of devices may incorporate fabric, if desired.

As shown in FIG. 1, item 10 may include a housing such as housing 12. Housing 12 may have a cylindrical shape of the type shown in FIG. 1 or other suitable shape (e.g., a pyramidal shape, a conical shape, a box shape such as a rectangular box shape, a spherical shape, etc.). Housing 12 may include support structures formed from metal, polymer, ceramic, glass, wood, other materials, and/or combinations of these materials. Item 10 may include fabric 14. Fabric 14 may form all or part of a housing wall or other layer in an electronic device, may form internal structures in an electronic device, or may form other fabric-based structures. Item 10 may be soft (e.g., item 10 may have a fabric surface that yields to a light touch), may have a rigid feel (e.g., the surface of item 10 may be formed from a stiff fabric), may be coarse, may be smooth, may have ribs or other patterned textures, and/or may be formed as part of a device that has portions formed from non-fabric structures of plastic, metal, glass, crystalline materials, ceramics, or other materials. For example, some or all of the upper surface of housing 12, the sidewall surfaces of housing 12, surfaces associated with lower portions of housing 12, and/or other portions of item 10 may be covered with fabric 14. In some configurations, fabric 14 may serve as a cosmetic cover for item 10 that is permeable to sound.

Fabric 14 may include strands of material such as strands 16. Fabric 14 may include warp knit fabric, weft knit fabric, woven fabric, spacer fabric, non-woven fabric, and/or hybrid fabric that includes one or more different types of fabric constructions. In some arrangements, fabric 14 may be free of woven fabric, weft knit fabric, and braided fabric and may be formed entirely of printed strands and/or non-printed strands that are added around a support structure.

Strands 16 may be single-filament strands (sometimes referred to as fibers or monofilaments) or may be strands of material formed by intertwining multiple monofilaments of material together (sometimes referred to as yarns or multifilaments). Strands 16 may include printed strands and non-printed strands. Printed strands in strands 16 may be monofilaments that are extruded or otherwise printed using additive manufacturing equipment (e.g., three-dimensional printing equipment) and/or using an extruder. Non-printed strands in strands 16 may be monofilaments and/or multifilaments that are fed from a bobbin or other strand source through a feeder. Combining printed strands with non-printed strands may provide fabric 14 with a robust structure that can better withstand the elements such as moisture and debris. This may be beneficial in arrangements where device 10 forms an outdoor speaker or other weather resistant electronic device.

Strands 16 may be formed from polymer, metal, glass, graphite, ceramic, natural materials such as cotton or bamboo, or other organic and/or inorganic materials and/or combinations of these materials. If desired, conductive coatings such as metal coatings may be formed on non-conductive material. For example, plastic strands in fabric 14 may be coated with metal to make them conductive. Reflective coatings such as metal coatings may be applied to make strands reflective. Strands may be formed from bare metal wires or metal wire intertwined with insulating monofilaments (as examples). Bare metal strands and strands of polymer covered with conductive coatings may be provided with insulating polymer jackets.

Conductive strands and insulating strands may be layered to form contact pads that can be electrically coupled to conductive structures in item 10 such as the contact pads of an electrical component. The contacts of an electrical component may also be directly coupled to an exposed metal segment along the length of a conductive yarn or monofilament.

Conductive and insulating strands may be layered to form conductive paths. The conductive paths may be used in forming signal paths (e.g., signal buses, power lines, etc.), may be used in forming part of a capacitive touch sensor electrode, a resistive touch sensor electrode, or other input-output device, or may be used in forming other patterned conductive structures. Conductive structures in fabric 14 may be used in carrying power signals, digital signals, analog signals, sensor signals, control signals, data, input signals, output signals, or other suitable electrical signals.

This is merely illustrative, however. If desired, fabric 14 may be free of conductive strands and may be formed mostly or entirely of insulating (e.g., polymer strands).

Fabric 14 may include strands 16 that are intertwined (e.g., interlaced) together and/or may include strands 16 that are layered together. Strands 16 may be interlaced using interlacing equipment such as weaving equipment, knitting equipment, or braiding equipment. Intertwined strands may, for example, form woven fabric, knit fabric, spacer fabric, braided fabric, etc. Fabric 14 may also or instead include strands 16 that are layered with other strands 16. Strands 16 may be layered using feeders, additive manufacturing equipment (e.g., three-dimensional printing equipment), extruding equipment, deposition equipment, laser printing equipment, powder printing equipment, casting equipment, jet printing equipment, and/or other suitable equipment. Additive manufacturing equipment may be used to build fabric 14 by printing layer-upon-layer of material. The layers of fabric 14 that are formed using additive manufacturing equipment may be fused (e.g., bonded) together or may be free to move relative to one another. The printed layers of fabric 14 may have different properties (e.g., different colors, thicknesses, constructions, shapes, geometries, sizes, features, magnetic properties, materials, amounts of stretch, flexibility, rigidity, conductivity, etc.). Printed strands (sometimes referred to as extruded strands, deposited strands, monofilament strands, etc.) may be layered with non-printed strands (sometimes referred to as additional strands, interlaced strands, multifilament strands, etc.) to form hybrid fabric.

Strands 16 may, for example, include fusible strands formed from a material that becomes soft and pliable above a certain temperature and solidifies upon cooling. Fusible materials may include thermosetting polymer material (e.g., thermosetting polyester, polyurethane, polyimide, or other thermosetting resin), thermoplastic material (e.g., thermoplastic polyester, nylon or other suitable polyamide, thermoplastic polyurethane, etc.), or other fusible material that becomes soft when heated to an appropriate temperature (e.g., between 60° C. and 140° C., between 60° C. and 160° C., 80° C. and 100° C., less than 180° C., etc.).

Item 10 may include additional mechanical structures such as polymer binder to hold strands 16 in fabric 14 together, support structures such as frame members, housing structures (e.g., an electronic device housing), and other mechanical structures.

Items such as item 10 may, if desired, include control circuitry 20. Control circuitry 20 may include microprocessors, microcontrollers, application-specific integrated-circuits, digital signal processors, baseband processors, and/or other controllers and may include storage such as random-access memory, read-only memory, solid state drives, and/or other storage and processing circuitry.

Control circuitry 20 may gather information from sensors and other circuitry in input-output devices 18 and may use input-output devices 18 to supply output. Input-output devices 18 may, for example, include audio devices such as microphones and speakers. Microphones can gather audio input (e.g., sound that passes through fabric 14). Speakers can produce audio output (e.g., sound that passes through fabric 14). Sensors in input-output devices 18 may include touch sensors, force sensors, capacitive sensors, optical sensors, proximity sensors, strain gauges, temperature sensors, moisture sensors, gas sensors pressure sensors, magnetic sensors, position and orientation sensors (e.g., accelerometers, gyroscopes, and/or compasses), and/or other sensors. Light-emitting diodes, displays, and other visual output devices may be used in supply visual output to a user. Buttons, joysticks, haptic output components, and/or other input-output components may be provided in input-output devices 18 to gather input from a user and to provide a user with output. Wireless circuitry in circuitry 20 (e.g., wireless local area network circuitry, cellular telephone circuitry, etc.) may be used to support wireless communications with external equipment.

Integrated circuits and other electrical components forming circuitry 20 and/or input-output devices 18 may be mounted in housing 12. Fabric 14 may cover the exterior of housing 12 (e.g., to hide electrical components in housing 12 from view). Fabric 14 may also be used in forming structural portions of housing 12 and/or other portions of item 10, may be used in forming straps, covers, wearable items, and/or other structures for items 10.

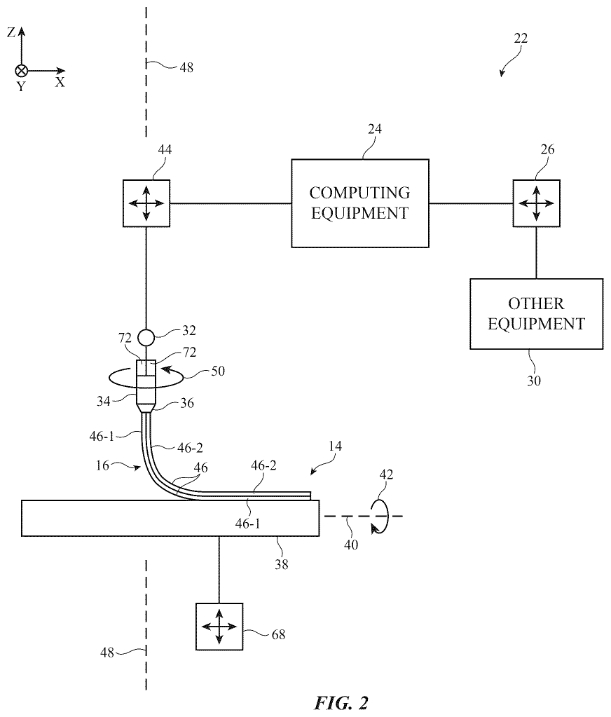

Illustrative fabrication equipment of the type that may be used in printing strands 16 to form fabric 14 is shown in FIG. 2. Fabrication equipment 22, which may sometimes be referred to as extruding equipment, three-dimensional printing equipment, or additive manufacturing equipment, may include computing equipment 24. Computing equipment 24 may issue commands to positioners such as computer-controlled positioners 44, 26, and 68. Computer-controlled positioner 44 may be used to control the position of one or more extruders such as extruder 34 (sometimes referred to as printing head 34, print head 34, dispensing head 34, etc.). Extruders 34 may be used to print strands 16 of fabric 14 onto support structure 38. Computer-controlled positioner 26 may be used to control the position of other equipment 30.

Equipment 30 may include dispensing heads for dispensing adhesive, dipping and curing equipment for dipping fabric 14 in an ultraviolet-light-curable adhesive and curing the adhesive with ultraviolet light, heating equipment for applying heat to fuse printed strands 16 and/or non-printed strands, stitching equipment, welding equipment, and/or other equipment for forming connections between printed strands.

If desired, other equipment 30 may include interlacing equipment (e.g., braiding equipment, knitting equipment, and/or weaving equipment) for interlacing strands 16 (e.g., to form interlaced fabric such as woven, knit, and/or braided fabric that can be incorporated into fabric 14), cutting equipment (e.g., a mechanical cutting tool, a laser cutting tool, or other equipment for cutting yarn) for cutting strands 16 and/or fabric 14, heating tools that may be used in applying heat to strands 16 and/or fabric 14 (e.g., a laser for supplying heat, a reflow oven, an inductive heating tool for heating solder, a heat gun, a lamp, hot bar equipment, a soldering iron tip, equipment for forming heat by applying current such as ohmic heating current to a conductive strand, etc.), equipment for laminating fabric to layers of plastic, metal, and/or other materials, equipment (e.g., pick-and-place equipment) for mounting integrated circuits, light-emitting diodes, sensors, buttons, and other electrical circuitry to fabric 14, insertion equipment (e.g., for inserting non-extruded strands and/or other non-extruded elements into fabric 14 during fabrication of fabric 14, for inserting strands 16 that were previously extruded into fabric 14, etc.), robotic assembly equipment, and/or other equipment for forming item 10. The equipment of FIG. 2 may be used to form fabric 14, to process fabric 14, and/or to perform other fabrication and processing operations on fabric 14.

Computing equipment 24 may include software for creating computer-aided designs (CADs) and/or may include storage for storing computer-aided designs created on other computing equipment. For example, computing equipment 24 may store a computer-aided design for a fabric item such as item 10 of FIG. 1 or other suitable fabric item. Computing equipment 24 may issue control signals to the rest of equipment 22 to instruct the rest of equipment 22 (e.g., extruder 34, positioners 44 and 26, etc.) to form fabric 14 using a sequence of steps. The sequence of steps may be used to build a three-dimensional, physical object that matches the computer-aided design (e.g., the design for a spherical fabric housing, a cylindrical fabric cover, or other fabric item) stored in computing equipment 24.

Print head 34 may be used to print (e.g., deposit, extrude, dispense, etc.) strands 16 to form fabric 14. If desired, print head 34 may be heated (e.g., to a temperature that is adjusted by computing equipment 24). Material sources 72 may dispense adjustable amounts of material such as material 46-1 and material 46-2 (e.g., molten polymer, thermoplastic polyurethane, nylon, liquids, gasses, powders made up of particles, wires, and/or other materials) into print head 34. Alternatively, materials 46 such as material 46-1 and material 46-2 may be fed to print head 34 from a bobbin such as bobbin 32. Bobbin 32 may feed one, two, three, or more than three materials with one or more different characteristics to print head 34 as print head 34 dispenses strand 16. The material(s) may be dispensed from extruder 34 through a nozzle such as nozzle 36 to form strands 16. Strands 16 (sometimes referred to as monofilament strands, printed strands, deposited strands, extruded strands, fused strands, etc.) may be dispensed onto a support structure such as support structure 38. Equipment 22 may include one, two, three, four, or more than four extruders 34 for printing strands 16 onto support structure 38. If desired, extruder 34 may print strands 16 to form individual layers that make up fabric 14. The layers of printed strands 16 in fabric 14 may be bonded, fused, stitched, welded, interlaced, or otherwise fixed to one another and/or the layers may be free to move relative to one another.

If desired, equipment 22 may include dual dispensing heads (e.g., extruder 34 may be combined with an adhesive dispensing head to print strands 16 while also coating strands 16 with adhesive).

In addition to or instead of using extruder 34 to print strands 16, a feeder may be used to feed strands 16 such as non-printed strands onto support structure 38 to form fabric 14. The feeder may operate in parallel with extruder 34 (e.g., at the same time) or may operate in sequence (e.g., printing strands 16 in one step and feeding strands in a separate later step, or vice versa). If desired, a feeder may add non-printed strands around printed strands to form individual layers that make up fabric 14. The layers of non-printed strands in fabric 14 may be bonded, fused, stitched, welded, interlaced, or otherwise fixed to one another and/or the layers may be free to move relative to one another. Similarly, layers of printed strands may be fixed to layers of non-printed strands or the layers may be free to move relative to one another.

Support structure 38 may have a flat surface, a curved surface, or any other suitable type of surface for receiving layers of strands 16. The position and surface shape of support structure 38 may be controlled using computer-controlled positioner 68. Support structure 38 may have a flat surface that moves along a linear direction (e.g., similar to a conveyor belt), or support structure 38 may have a curved surface that rotates about an axis such as axis 40 (e.g., in direction 42 and/or in the opposite direction). In some arrangements, support structure 38 may be a rotating cylinder, sphere, or any other three-dimensional structure that rotates about axis 40 while extruder 34 prints strands 16 onto support structure 38. Support structure 38 may be a dedicated support structure for use during manufacturing, or support structure 38 may be an electronic device housing structure that forms part of electronic device 10 (e.g., support structure 38 may be part of housing 12).

Fabric 14 may be formed entirely of printed strands, may be formed entirely of non-printed strands, or may be a hybrid fabric formed from a combination of printed strands 16 and non-printed strands 16. Applying printed strands and/or non-printed strands to a rotating support structure may allow fabric 14 to form a seamless loop (e.g., a continuous and seamless web of cylindrical fabric, spherical fabric, etc.) that may be difficult or impossible to form using traditional weaving or knitting equipment. If desired, the loop of fabric may have printed inner layers (e.g., to form a robust, durable, and water-resistant core to cover electronic components while still allowing sound to permeate) and non-printed outer layers (e.g., to form a soft outer layer with a textile look and feel).

Equipment 22 may include components that modify strands 16 and/or fabric 14 in response to control signals from computing equipment 24. For example, equipment 22 may include heating components that supply adjustable amounts of heat to strands 16, light-emitting components that supply adjustable amounts of light to strands 16, magnetic components (e.g., one or more electromagnets) that supply adjustable amounts of magnetic field to strands 16, mechanical tools (e.g., equipment for selectively roughening the surface of strands 16 using airborne particles, using a grinding wheel, embossing wheels, etc.), coating equipment (e.g., equipment for selectively spraying coatings onto strands 16), and/or other components for varying the properties of strands 16 as strands 16 are printed and/or fed onto support structure 38.

Fabric 14 formed using equipment 22 may have properties that vary along one or more dimensions of the fabric. For example, some strands 16 may be uniform along their lengths and some strands 16 may be non-uniform along their lengths. Segments of a given printed strand 16 may have different properties than other segments of the same strand 16. For example, optical properties such as optical transparency (opacity), reflectivity, color, and/or any other optical characteristic may be varied along the length of a given strand 16 and/or may be from strand-to-strand. When these strands 16 are incorporated into fabric 14, fabric 14 may exhibit corresponding regions with different transparency values, different reflectivity values, and/or different colors. Mechanical properties may also be varied in strands 16. As an example, tensile strength, rigidity, flexibility, sound permeability, surface roughness, porosity, hydrophobicity, strand diameter, stiffness, thermal conductivity, and/or other properties may be different at different portions along the length of strand 16 and/or from strand-to-strand. Magnetic properties (e.g., the magnetic permeability and/or magnetization of strands 16), electrical properties (e.g., conductivity and radio-transparency, etc.), and/or other physical properties may also be varied along the length of strand 16 and/or from strand-to-strand.

Bobbin 32 may feed one, two, three, or four or more materials 46 (e.g., materials with one or more different characteristics as described above) such as materials 46-1 and 46-2 to print head 34. As print head 34 is dispensing strand 16, nozzle 36 (and/or print head 34) may rotate about axis 48 in direction 50 (and/or in the opposite direction). The rotation of print head 34 may be digitally controlled by computing equipment 24. This allows computing equipment 34 to select which of the different materials 46 should be facing which direction. In other words, computing equipment 24 may control and adjust the orientation and width-wise position (e.g., the position within the Y-Z plane of FIG. 2) of a given one of materials 46 of strand 16 along the length of strand 16 (e.g., along the X-dimension of FIG. 2) by selectively rotating print head 34 as strand 16 is dispensed.

In general, adjustments to bobbin 32, adjustments to sources 72, adjustments to positioners 44, 26, and/or 68, adjustments to the nozzle of extruder 34 (e.g., the cross-sectional shape of the nozzle, the size of the nozzle, the speed at which the nozzle rotates and/or moves relative to support structure 38, and/or adjustments to strand pull rate (e.g., the rate at which strand 16 is pulled from the nozzle) can be made (e.g., in response to control signals from computing equipment 24).

Consider a scenario in which materials 46-1 and 46-2 have different properties. Material 46-1 may have a first property (e.g., a first color, a first material type, a first modulus of elasticity, a first melting temperature, a first conductivity, a first opacity, etc.) and material 46-2 may have a second property different from the first property (e.g., a second color, a second material type, a second modulus of elasticity, a second melting temperature, a second conductivity, a second opacity, etc.). Computing equipment 24 may rotate print head 34 to adjust which material faces toward substrate 38 (and is therefore hidden from view) and which material faces away from substrate 38 (and is therefore visible to a viewer). In some segments of strand 16, material 46-1 may be stacked on top of material 46-2. In these segments, the first property may be present on the exterior of fabric 14 (e.g., on a user-facing side of fabric 14 and/or a user-facing side of an electronic device such as user-facing outer surface 74 of device 10 of FIG. 1). In other segments of strand 16, material 46-2 may be stacked on top of material 46-1. In these segments, the second property may be present on the exterior, user-facing side 74 of fabric 14.

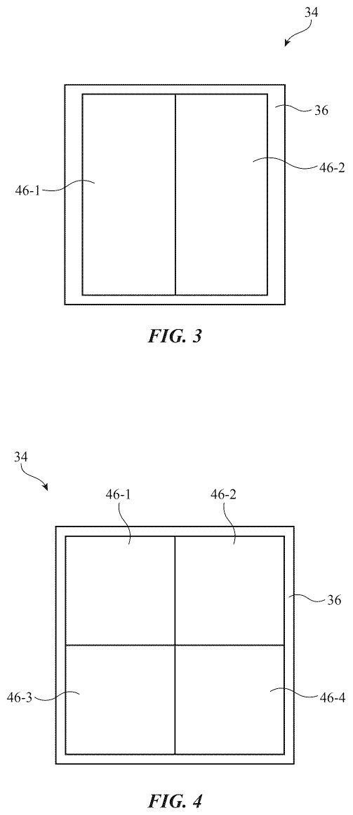

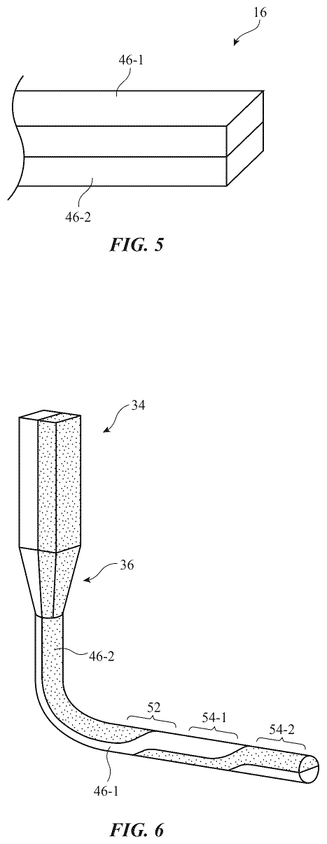

FIG. 3 is a bottom view of an illustrative nozzle 36 having a rectangular (e.g., square) cross-section. In the example of FIG. 3, first and second materials 46-1 and 46-2 are dispensed from nozzle 36. The rectangular cross-sectional shape of nozzle 36 causes materials 46-1 and 46-2 to form a strand 16 with a matching rectangular cross-section (e.g., as shown in FIG. 5). By controlling rotation of nozzle 34, computing equipment 24 can adjust the orientation of materials 46-1 and 46-2 relative to substrate 38 (FIG. 2) along the length of strand 16. In some segments of strand 16, material 46-1 may face toward substrate 38 and material 46-2 may face away from substrate (and may be visible and/or touchable by a user on user-facing surface 74 of FIG. 1). In other segments of strand 16, material 46-2 may face toward substrate 38 and material 46-1 may face away from substrate 38 (and may be visible and/or touchable by a user on user-facing surface 74 of FIG. 1). The use of a rectangular cross-section for nozzle 36 is merely illustrative. If desired, nozzle 36 may have a round (e.g., circular, oval, etc.) cross-section and/or any other suitable cross-sectional shape.

FIG. 4 is a bottom view of an illustrative nozzle 36 showing how more than two materials 46 with one or more different properties may be dispensed from print head 34 to form strand 16. In the example of FIG. 4, first, second, third, and fourth materials 46-1, 46-2, 46-3, and 46-4 are dispensed from nozzle 36. By controlling rotation of nozzle 34, computing equipment 24 can adjust the orientation of materials 46-1, 46-2, 46-3, and 46-4 relative to substrate 38 (FIG. 2) along the length of strand 16. In some segments of strand 16, materials 46-1 and 46-2 may face toward substrate 38 and materials 46-3 and 46-4 may face away from substrate 38 (and may be visible and/or touchable by a user on user-facing surface 74 of FIG. 1). In other segments of strand 16, materials 46-3 and 46-4 may face toward substrate 38 and materials 46-1 and 46-2 may face away from substrate 38 (and may be visible and/or touchable by a user on user-facing surface 74 of FIG. 1). In other segments, materials 46-1 and 46-3 may face toward substrate 38 and materials 46-2 and 46-4 may face away from substrate 38 (and may be visible and/or touchable by a user on user-facing surface 74 of FIG. 1). In other segments of strand 16, materials 46-2 and 46-4 may face toward substrate 38 and materials 46-1 and 46-3 may face away from substrate 38 (and may be visible and/or touchable by a user on user-facing surface 74 of FIG. 1).

FIG. 5 is a perspective view of an illustrative strand 16 formed using equipment 22 of FIG. 2. In the example of FIG. 5, strand 16 has been printed using print head 34 and a nozzle 36 with a rectangular cross-section of the type shown in FIG. 3. Strand 16 also has a rectangular cross-section (e.g., four planar surfaces extending along the length of strand 16). Strand 16 may have some segments in which material 46-1 is on top of material 46-2 (and therefore visible on user-facing surface 74 of device 10 of FIG. 1) and other segments in which material 46-2 is on top of material 46-1 (and therefore visible on user-facing surface 74 of device 10 of FIG. 1).

FIG. 6 is a perspective view of an illustrative print head 34 having a rotating nozzle 36 from which materials 46-1 and 46-2 of strand 16 may be dispensed. Computing equipment 24 may control the rotation of nozzle 36 to adjust the orientation and/or position of materials 46-1 and 46-2 along the length of strand 16. During printing of strand segments 54-1, rotation of nozzle 36 is paused while material 46-1 is on top of material 46-2. This allows material 46-1 in segments 54-1 to be visible on the outer user-facing surface 74 of device 10 of FIG. 1, if desired. During printing of strand segments 54-2, rotation of nozzle 36 is paused while material 46-2 is on top of material 46-1. This allows material 46-2 in segments 54-2 to be visible on the outer user-facing surface 74 of device 10 of FIG. 1, if desired. During printing of strand segments 52, nozzle 36 may be rotated to adjust which of materials 46-1 and 46-2 is on top and visible to a user.

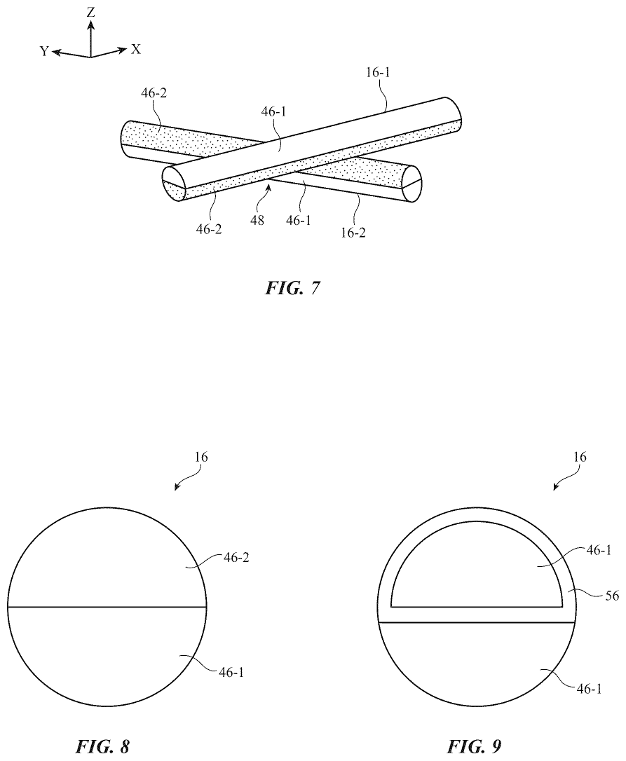

The ability to digitally control the rotational orientation of a given material within strand 16 allows computing equipment 24 to adjust whether and how overlapping strands 16 in fabric 16 interact with each other. As shown in FIG. 7, for example, print head 34 may print a first strand such as strand 16-1 with first material 46-1 facing an upward direction (e.g., the positive Z-direction of FIG. 7) and second material 46-2 facing a downward direction (e.g., the negative Z-direction of FIG. 7). Strand 16-1 may, for example, extend parallel to the X-axis of FIG. 7. Print head 34 may print a second strand such as strand 16-2 with first material 46-1 facing a downward direction (e.g., the negative Z-direction of FIG. 7) and second material 46-2 facing an upward direction (e.g., the positive Z-direction of FIG. 7). Strand 16-2 may overlap (e.g., cross over) strand 16-1 and may be non-parallel with strand 16-1. Strand 16-2 may, for example, extend parallel to the Y-axis of FIG. 7. The circular cross-sectional shape of strands 16-1 and 16-2 of FIG. 7 is merely illustrative. If desired, strand 16-1 and/or strand 16-2 may have a rectangular cross-sectional shape and/or any other suitable cross-sectional shape.

Materials 46-1 and 46-2 may be different types of materials that do not bond to one another. For example, materials 46-1 and 46-2 may have different thermosetting temperatures and/or may otherwise have different properties that cause materials 46-1 and 46-2 to remain separate from one another rather than fusing together (e.g., material 46-1 may be formed from thermoplastic polyurethane, whereas material 46-2 may be a thermoplastic elastomer, as an example). When material 46-2 of strand 16-1 contacts material 46-2 of strand 16-2 at a crossover location of the type shown in FIG. 7, materials 46-2 and 46-2 may bond together and form a connected joint such as connected (e.g., fused) joint. Similarly, when material 46-1 of strand 16-1 contacts material 46-1 of strand 16-2 at a crossover location, materials 46-1 and 46-1 may bond together and form a fused joint. On the other hand, when material 46-1 of strand 16-1 contacts material 46-2 of strand 16-2 at a crossover location, material 46-1 of strand 16-1 does not bond with material 46-2 of strand 16-2, thereby allowing strand 16-1 to slide relative to strand 16-2 at that crossover location. When material 46-2 of strand 16-1 contacts material 46-1 of strand 16-2 at a crossover location, material 46-2 of strand 16-1 does not bond with material 46-1 of strand 16-2, thereby allowing strand 16-1 to slide relative to strand 16-2 at that crossover location.

By selectively rotating nozzle 36 when printing strands 16-1 and 16-2, computing equipment 34 can control where connections between strands 16 are formed in fabric 14 and where strands 16 are permitted to slide relative to one another (e.g., where strand 16-1 is permitted to slide relative to strand 16-2). For example, fabric 14 may include some crossover locations in which material 46-2 of strand 16-1 contacts and is fused with material 46-2 of strand 16-2; may include some crossover locations in which material 46-1 of strand 16-1 contacts and is fused with material 46-1 of strand 16-2; may include some crossover locations in which material 46-1 of strand 16-1 contacts and slides relative to material 46-2 of strand 16-2; and/or may include some crossover locations in which material 46-2 of strand 16-1 contacts and slides relative to material 46-1 of strand 16-2.

FIG. 8 is a side view of an illustrative strand 16 with a round cross-section (e.g., a circular cross-section) and having first and second materials 46-1 and 46-2 with different characteristics. If desired, strands 16 having circular cross-sections may include more than two materials (e.g., three materials, four materials, more than four materials, etc.) with one or more different characteristics.

FIG. 9 is a side view of an illustrative strand 16 showing how one or more of materials 46 in strand 16 may be enclosed within a dissolvable envelope such as dissolvable material 56. Dissolvable material 56 may be formed from polyvinyl alcohol or other suitable dissolvable material and may be dissolved after fabric 16 is incorporated into fabric 14. Dissolvable material 56 may be used to enclose a first portion of material 46-1 and without enclosing a second portion of material 46-1 in strand 16-1. This helps prevent the first portion of material 46-1 from bonding to the second portion of material 46-1 (or other strands 16 having material 46-1) until dissolvable material 56 is dissolved, which in turn allows for selective connections between strands 16. If desired, dissolvable material 56 may be applied to other materials in strands 16 (e.g., material 46-2 and/or any other materials 46 of strands 16).

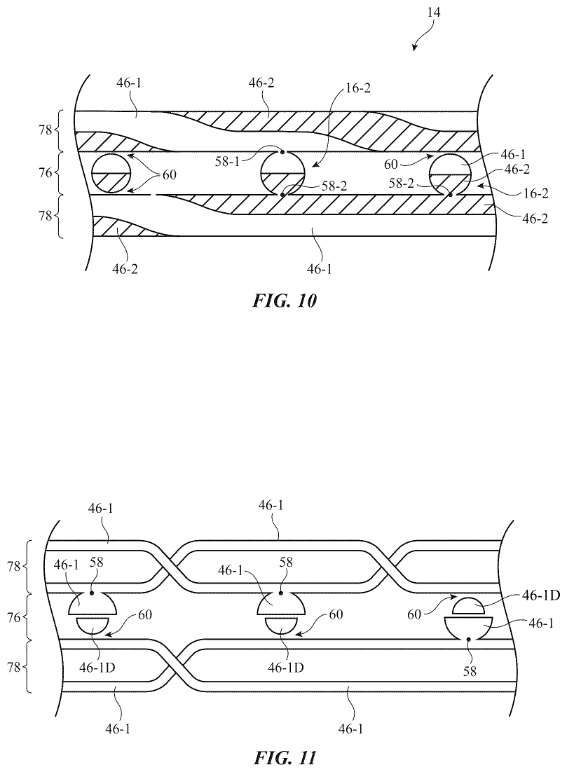

FIGS. 10 and 11 are side views of illustrative fabric 14 showing how selective connections (e.g., fused joints) can be made at certain crossover locations between printed strands 16 in fabric 14 while other crossover locations may remain unconnected (e.g., sliding). In the example of FIG. 10, strands 16 of fabric 14 each include multiple materials 46 such as material 46-1 and material 46-2 with one or more different characteristics, as described in connection with FIGS. 1-9 (e.g., different colors, different melting temperatures, different moduli of elasticity, etc.). For example, material 46-1 and 46-2 may be formed from two different materials that do not bond with one another (e.g., material 46-1 may be formed from thermoplastic polyurethane and material 46-2 may be formed from thermoplastic elastomer, as an example). If desired, materials 46-1 and 46-2 may otherwise have a similar look and feel, or materials 46-1 and 46-2 have one or more additional properties that differ from one another (e.g., different colors, textures, stiffness, stretch, conductivity, etc.).

Some of strands 16 such as strands 16 in region 76 may be interposed between first and second fabric portions such as fabric portions (regions) 78. In crossover locations where material 46-1 of strands 16 in region 76 overlaps and contacts material 46-1 of strands 16 in regions 78, a connection such as connection 58 may be formed, thereby fixing strands 16 together at those crossover locations. At some fused connections such as connection 58-1 of strand 16-1, material 46-1 of strand 16-1 in region 76 may fuse with (e.g., melt and solidify together with) material 46-1 of overlapping strand 16 in region 78. At other connections such as connections 58-2, material 46-2 of strands 16-1 and 16-2 in region 76 may fuse with (e.g., melt and solidify together with) material 46-2 of overlapping strand 16 in region 78. On the other hand, in crossover locations where material 46-1 of strands 16 in region 76 overlaps and contacts material 46-2 of strands 16 in regions 78, material 46-1 may slide relative to material 46-2 and an unconnected crossover point 60 may be formed, thereby allowing overlapping strands 16 at those crossover locations 60 to slide relative to one another. Unconnected crossover points 60 may also be formed where material 46-2 of strands 16 in region 76 overlaps, contacts, and slides relative to material 46-1 of strands 16 in regions 78.

In the example of FIG. 11, strands 16 of fabric 14 include the same material 46-1, but a portion of material 46-1 may initially be enclosed within a dissolvable envelope such as dissolvable material 56 of FIG. 9. In particular, strands 16 in regions 76 may have a first portion such as portion 46-1D that is initially enclosed within dissolvable material 56 (e.g., during printing), while the remaining material 46-1 of strands 16 in region 76 may not be enclosed by any dissolvable material 56. This helps prevent material 46-1D of region 76 from bonding with overlapping material 46-1 of region 78 during printing. The remaining material 46-1 in region 76 that is not covered with dissolvable material 56 during printing may fuse with (e.g., melt and solidify together with) material 46-1 in regions 78, thereby forming fused joints 58 in those crossover locations.

Following printing, fabric 14 (e.g., material 46-1 and material 46-1D) may cool and solidify. Fabric 14 may then be washed or otherwise processed to remove dissolvable material 56. Because material 46-1D has already cooled and solidified, it does not form fused joints with material 46-1 of regions 78. Rather, as shown in FIG. 11, sliding crossover points 60 are formed between material 46-1D of region 76 and material 46-1 of regions 78.

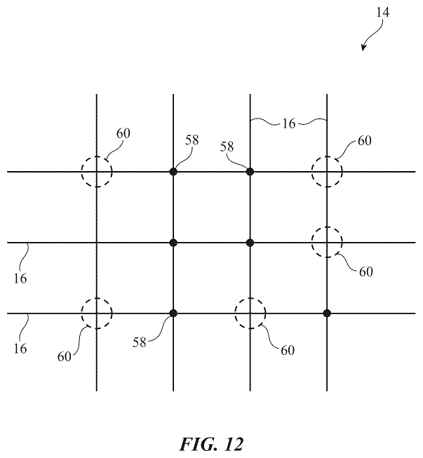

FIG. 12 is a top view of an illustrative fabric having selective connections between strands 16 as discussed in connection with FIGS. 7-11. Fabric 14 may be formed from printed strands 16, one or more of which may include multiple materials 46 with different characteristics (e.g., different colors, different melting temperatures, different moduli of elasticity, etc.). In unconnected crossover locations 60, overlapping strands 16 (e.g., overlapping warp and weft strands) may be permitted to slide relative to one another. This may be achieved by ensuring that when strands 16 at locations 60 are printed, the orientation of nozzle 36 is rotated such that material 46-1 of a first strand 16 is oriented towards and contacts material 46-2 of an overlapping second strand 16, and such that material 46-2 of the first strand is oriented towards and contacts material 46-1 of the second strand 16. At connections 58, overlapping strands 16 may be bonded (e.g., fused) together. Connections 58 may be achieved by ensuring that when strands 16 at those crossover locations are printed, the orientation of nozzle 36 is rotated such that material 46-1 of a first strand 16 is oriented towards and contacts material 46-1 of the overlapping second strand 16, or such that material 46-2 of the first strand is oriented towards and contacts material 46-2 of the second strand 16.

FIG. 12 shows how a given one of strands 16 may have both fused joints 58 with some overlapping strands 16 and sliding, unconnected crossover points 60 with other overlapping strands 16. For example, a first strand 16 may cross over second and third strands 16 at respective first and second crossover locations. At the first crossover location, the first material of the first strand may face toward and fuse with the first material of the second strand. At the second crossover location, the first material of the first strand may face away from and slide relative to the first material of the third strand.

If desired, material 46-1 may be conductive and material 46-2 may be insulating. With this type of configuration, electrical connections through which current may flow may be made between overlapping strands 16 in which material 46-1 of a first strand 16 contacts material 46-1 of a second strand 16. In crossover locations where material 46-2 of a first strand 16 contacts material 46-1 or material 46-2 of a second strand 16, no electrical connection may be made and current may not flow through that crossover junction.

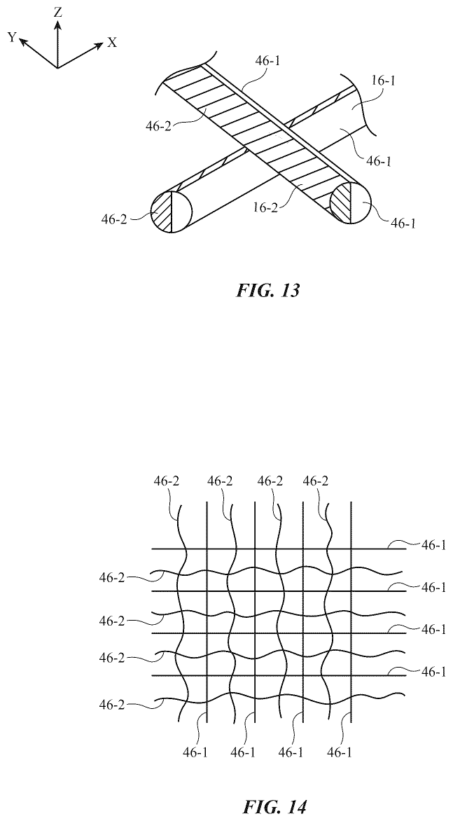

FIG. 13 is a perspective view of illustrative strands 16. Print head 34 may print a first strand such as strand 16-1 with first material 46-1 facing a first direction (e.g., the negative Y-direction of FIG. 13) and second material 46-2 facing a second, opposite direction (e.g., the positive Y-direction of FIG. 13). Strand 16-1 may, for example, extend parallel to the X-axis of FIG. 13. Print head 34 may print a second strand such as strand 16-2 with first material 46-1 facing one direction (e.g., the positive X-direction of FIG. 13) and second material 46-2 facing an opposite direction (e.g., the negative X-direction of FIG. 13). Strand 16-2 may overlap strand 16-1 and may be non-parallel with strand 16-1. Strand 16-2 may, for example, extend parallel to the Y-axis of FIG. 13. The circular cross-sectional shape of strands 16-1 and 16-2 of FIG. 13 is merely illustrative. If desired, strand 16-1 and/or strand 16-2 may have a rectangular cross-sectional shape and/or any other suitable cross-sectional shape.

Materials 46-1 and 46-2 may be different types of materials that do not bond to one another. For example, materials 46-1 and 46-2 may have different thermosetting temperatures and/or may otherwise have different properties that cause materials 46-1 and 46-2 to remain separate from one another rather than fusing together (e.g., material 46-1 may be formed from thermoplastic polyurethane, whereas material 46-2 may be a thermoplastic elastomer, as an example).

Using materials 46-1 and materials 46-2 that do not bond with one another and that are printed in a side-by-side orientation of the type shown in FIG. 13 may allow materials 46-1 and 46-2 to separate from one another after being incorporated into fabric 14. As shown in FIG. 14, for example, fabric 14 formed using printed strands 16 of the type shown in FIG. 13 may allow material 46-1 to separate from material 46-2. Bonds may form where material 46-1 of one strand 16 contacts material 46-1 of another overlapping strand 16, thereby creating a matrix of connected filaments, whereas material 46-2 may form a matrix of loose filaments.

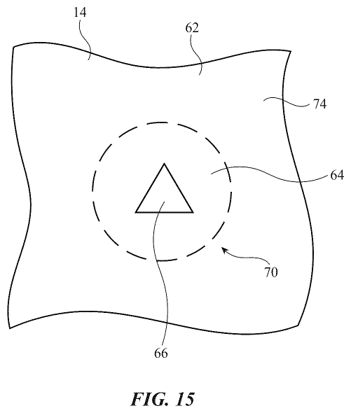

FIG. 15 is a top view of an illustrative fabric 14 formed from printed strands 16 having materials 46 with one or more different properties, as discussed in connection with FIGS. 1-14. One or more of strands 16 of fabric 14 may, for example, include a first material 46-1 with a first modulus of elasticity and a second material 46-2 with a second modulus of elasticity that is higher than the first modulus of elasticity. This allows computing equipment 34 to select which areas of fabric 14 will be rigid and which areas of fabric 14 will be soft by rotating nozzle 36 so that the desired material is on top (e.g., on user-facing surface 74). In regions where a more rigid feel is desired, computing equipment 34 may control nozzle 36 to print strand 16 such that the stiffer material 46 (e.g., the material with the higher modulus of elasticity) faces away from substrate 38 (FIG. 2), while the more flexible material 46 faces toward substrate 38. In regions where a more flexible feel is desired, computing equipment 34 may control nozzle 36 to print strand 16 such that the more flexible material 46 (e.g., the material with the lower modulus of elasticity) faces away from substrate 38, while the stiffer material 46 faces toward substrate 38.

As an example, fabric 14 may form a device housing structure with input-output devices such as input device 70 (e.g., a button, touch sensor, or other input device). Fabric 14 may form an outer layer of input device 70 or may otherwise overlap the input device 70. Fabric 14 may include regions that overlap input device 70 such as regions 64 and 66, whereas other regions of fabric 14 such as region 62 may be non-overlapping with input device 70. It may be desirable to make region 64 of fabric 14 more flexible than surrounding region 62 of fabric 14 (e.g., so that input device 70 can be more easily actuated). In region 62, print head 34 may print strands 16 with the stiffer material 46 on user-facing surface 74 (and with the more flexible material facing the opposite direction). In region 64, print head 34 may print strands 16 with the more flexible material 46 on user-facing surface 74 (and with the stiffer material facing the opposite direction).

If desired, strands 16 may also or instead include strands 16 formed from materials 46 with different colors. Region 66 of fabric 14 may be formed with a first color on user-facing surface 74 (and the second color facing the opposite direction), whereas region 62 and/or region 64 may be formed with the second color on user-facing surface 74 (and the first color facing the opposite direction). In region 66, print head 34 may print strands 16 with the first color material 46 on user-facing surface 74 (and with the second color material facing the opposite direction). In regions 62 and 64, print head 34 may print strands 16 with the second color material 46 on user-facing surface 74 (and with the first color material facing the opposite direction). Region 66, which is visually distinct from surrounding regions 64 and 62 of fabric 14, may form a label for input device 70 (e.g., region 66 may have a symbol shape, a plus sign shape, a minus sign shape, a pause or play shape, a letter shape, and/or any other suitable shape that indicates what function is performed by input device 70).

The foregoing is merely illustrative and various modifications can be made to the described embodiments. The foregoing embodiments may be implemented individually or in any combination.

What is claimed is:

1. A fabric, comprising:
a web of printed strands, wherein the printed strands each comprise first and second materials;
a first fabric region in which the first material faces a first direction and the second material faces a second direction opposite the first direction; and
a second fabric region in which the second material faces the first direction and the first material faces the second direction.

2. The fabric defined in claim 1 wherein the first material has a first color and the second material has a second color that is different from the first color.

3. The fabric defined in claim 2 wherein the first region overlaps an input device and wherein the first material forms a label for the input device.

4. The fabric defined in claim 1 wherein the first material has a first modulus of elasticity and the second material has a second modulus of elasticity that is different from the first modulus of elasticity.

5. The fabric defined in claim 4 wherein the first region overlaps an input device and wherein the first modulus of elasticity is lower than the second modulus of elasticity.

6. The fabric defined in claim 1 wherein the web of printed strands includes a fuse crossover location in which a first one of the printed strands crosses over and is fused to a second one of the printed strands and includes a sliding crossover location in which a third one of the printed strands crosses over and slides relative to a fourth one of the printed strands.

7. The fabric defined in claim 6 wherein the first and second materials have different melting temperatures.

8. The fabric defined in claim 1 wherein the web of printed strands forms a seamless loop.

9. The fabric defined in claim 8 wherein the seamless loop surrounds a speaker and is configured to transmit sound from the speaker.

10. The fabric defined in claim 1 wherein at least one of the first or second materials comprises thermoplastic polyurethane.

11. A printed strand, comprising:
a first material extending along a length of the printed strand; and
a second material extending along the length of the printed strand, wherein the first and second materials have at least one different characteristic, wherein the printed strand has a first strand segment in which the first material faces a first direction and the second material faces a second direction opposite the first direction, and wherein the printed strand has a second strand segment in which the second material faces the first direction and the first material faces the second direction.

12. The printed strand defined in claim 11 wherein the at least one different characteristic is selected from the group consisting of: color, stiffness, and melting temperature.

13. The printed strand defined in claim 11 wherein the printed strand has a cross-sectional shape selected from the group consisting of: rectangular and circular.

14. The printed strand defined in claim 11 further comprising third and fourth materials that extend along the length of the printed strand.

15. The printed strand defined in claim 14 wherein the printed strand has a third strand segment in which the third material faces a third direction and the fourth material faces a fourth direction opposite the third direction and wherein the printed strand has a fourth strand segment in which the fourth material faces the third direction and the third material faces the fourth direction.

16. Fabric, comprising:
a web of printed strands, wherein the printed strands include:
a first printed strand that comprises first and second materials extending along a length of the first printed strand; and
second and third printed strands that cross over the first printed strand at respective first and second crossover locations, wherein the second and third printed strands each comprise the first and second materials extending along respective lengths of the second and third printed strands, wherein the first material of the first printed strand faces toward and is fused to the first material of the second printed strand at the first crossover location, and wherein the first material of the first printed strand faces away from and is sliding relative to the first material of the third printed strand at the second crossover location.

17. The fabric defined in claim 16 wherein the first and second materials are different colors.

18. The fabric defined in claim 16 wherein the first and second materials have different melting temperatures.

19. The fabric defined in claim 16 wherein the printed strands have a cross-sectional shape selected from the group consisting of: rectangular and circular.

20. The fabric defined in claim 16 wherein the web of printed strands forms a seamless loop around a speaker and is configured to transmit sound from the speaker.
